(19) United States
(12) Patent Application Publication
(10) Pub. No.: US 2009/0308868 A1
(43) Pub. Date: Dec. 17, 2009

(54) Flow limiter production process

(76) Inventor: Benoit Portier, (US)

Correspondence Address: Sandra J. Thompson, 335 Knoch Knolls Rd., Naperville, IL, 60565, US

(21) Appl. No.: 12/075,327

(22) Filed: Mar. 11, 2008

(30) Foreign Application Priority Data
Mar. 13, 2007 (EP) 07 005 148.7

(51) Int. Cl. B65D 51/00; B23P 11/02; B65D 6/40

(52) U.S. Cl. 220/200; 29/453; 220/601

(57) ABSTRACT

The invention refers to a production process for producing a container for loosely stored products, characterized in that a flow-limiting device (12) is provided with a seal (50, 52) and inserted into a container cap (56), and that the combination of sealed flow-limiting device (12) and container cap (56) is put on and/or into a container body (10), and that said seal (50, 52) is sealed against said container body (10), preferably by induction heating.

### TECHNICAL FIELD

The present invention relates to a process for producing a container for receiving loosely stored products, and the containers made by such process.

### BACKGROUND OF THE INVENTION

Prescription drugs or food supplements, like vitamins are often manufactured in the form of tablets or pills. For storage the tablets or pills are often loosely packaged in containers having a cylindrically shape and having a cap to releasably sealing container opening. To increase the ease of handling, a flow-limiting device may be provided which may be integrally molded or may be used as an insert filling the container opening. The flow-limiting device is intended to reduce the number of tablets or pills distributed on one time, ideally allows the transition of only a single tablet, i.e., one tablet at a time. Such pill trapping component adapted to be positioned in the neck portion of a conventional pill container is e.g. disclosed in CA 2,130,881. The pill trapping component selectively traps some of the pills contained in the pill container. The pill trapping component comprises a substantially cylindrical wall. A retaining wall is extending integrally from a retaining wall segment of the inner surface of the cylindrical wall. The retaining wall is extending partially across a sectional area circumscribed by the cylindrical wall. The retaining wall is defining a trapping component passage between a peripheral edge of the retaining wall and an opposite segment of the cylindrical wall. The outer diameter of the cylindrical wall is dimensioned and configured in order to be slidably insertable into a neck dispensing portion of a conventional pill container such that the cylindrical wall outer surface frictionally abuts against the neck portion side wall inner surface. The friction between the pill trapping component cylindrical wall outer surface and the neck portion side wall inner surface prevents the pill trapping component from falling into the pill containing portion of the pill container.

A further container, which is in particular suitable for the storage of moisture sensitive test strips, is disclosed in US 2006/0169603 A1. The container comprises a cover made from two parts, namely a cover base and a cover lid. During use only the cover lid is opened for taking out the goods whereas the cover base remains fixed in the container opening. At the lower surface of the cover base is received a desiccant-containing body. A central through-opening is provided in the cover base which is firmly sealed by sealing means provided between the cover lid and the cover base. The cover base has essentially an L-shape, with the desiccant-containing body being received between the legs of L. At the outer circumference of the legs are provided sealing rims. During manufacturing of the container the cover base may be fixed in the container opening by pressing the cover base into the container opening such that the sealing rings act against a slightly thinner portion of the wall of the container.

A still further type of a dispenser for dispensing one or more items, such as pills, from a container is disclosed in U.S. Pat. No. 4,530,447. The dispensing member is located at or near the top of the container and has an aperture. When the container is closed by a cover and inverted, an item such as a pill passes through the aperture and is positioned between the cover and the top surface of the dispensing member. When the container is turned back to its initial position and the cover removed, a pill can be taken off the outer surface of the dispensing member.

Such containers for loosely storage of tablets or similar goods are usually produced at a corresponding manufacturer and then transported to another company for being filled with the corresponding goods. In particular at the production site of the manufacturer of the goods it should be possible to fill and close the container in an easy manner. The tablets usually are filled into the container through a container opening. To allow a fast filling the container opening should be as large as possible. Therefore, the flow limiting device may only be mounted in the container opening after the filling with goods. In particular when using a container which is closed with a screw cap, after filling the container with the goods the flow limiting device has to be inserted into the container opening and then the opening has to be closed with the screw cap. Preferably the opening of the flow limiting device is covered with an aluminum foil to further improve protection of the goods in the container from moisture and oxygen during shipping and storage. Such aluminum foil has to be welded onto the outside surface after the flow limiting device has been inserted into the container opening.

### OBJECTS AND SUMMARY OF THE INVENTION

Thus, it is an object of the invention to provide a production process for producing a container for loosely stored products which allows an easy assembly of the container after the container has been filled with goods, like tablets or pills.

This object is settled by the features of claim 1. Advantageous developments may be taken from the subclaims.

According to the present invention a flow-limiting device is preassembled in a container cap. The preassembled combination of flow-limiting device and container cap is then put on and/or into a container body and the flow-limiting device is fixed in a container opening of the container body.

Since the flow-limiting device is preassembled with the container cap, after filling the container with goods, like tablets or pills, the flow-limiting device may be mounted to the container together with the container cap in a single step. When opening the container again by removing the container cap the flow-limiting device remains in the container opening restricting the transition to only few, ideally only one tablet at a time.

According to an. embodiment of the present invention the flow-limiting device is provided with a seal and inserted into the container cap. The combination of sealed flow-limiting device and container cap is put on and/or into a container body, and the seal is sealed against the container body, preferably by induction heating. After closing the container the seal is sealed against the container body thereby obtaining a tight seal of the container opening. For taking the loosely stored products out from the container, the customer may break the seal thereby getting access to the container opening.

The seal preferably is made from a material that may be heat-welded to the container body. However, it is also possible that the seal is provided with an adhesive layer, which adheres to the flow-limiting device and to the container body when pressed against a corresponding surface of the container body after insertion of the flow-limiting device, e.g. in a container opening.

According to a preferred embodiment an outer circumference of the flow limiting device corresponds to an inner circumference of a container opening and said seal is placed on an upside surface of said flow limiting device and protrudes from said outer circumference of said flow limiting device. When assembling the combination of sealed flow-limiting device and container cap to the container body, the flow-limiting device is fittingly inserted into the opening of the container and may be fixed in the container opening by e.g. frictional forces. The seal situated on top of the flow-restricting device and protruding from its outer circumference abuts at the upper peripheral edge of the container opening and then may be sealed to the edge by e.g. induction heating.

The seal preferably has the form of a flat disk having a diameter corresponding at least to the outer diameter of the container opening.

The seal may protrude also outwardly from the outer circumference of the container opening after assembling the container thereby allowing an easy removal of the seal by a customer wishing to take a tablet or pill out from the container. According to a further embodiment, the seal may be provided with extensions protruding outwardly from the outer circumference of the container opening.

According to an embodiment of the invention at least one tab is provided extending outwardly from the circumference of the seal thereby allowing an easy opening of the seal.

According to a preferred embodiment the seal is formed by an aluminum foil. The aluminum foil further improves the tightness of the container against moisture and oxygen during storage.

For attaching the aluminum foil to the flow-limiting device by e.g. heat-welding, according to a preferred embodiment a layer of a heat welding material, preferably polyethylene, propylene or any other polymer compatible for sealing said seal to the flow-limiting device or to the container body, is placed onto the aluminum foil and then the aluminum foil is sealed to said flow-limiting device with the side the plastic material is placed on.

To improve tightness of the container after reopening for removing tablets from the container, a disc made of an elastic material may be placed onto said aluminum foil. When mounting the flow-limiting device in the container cap, the disc made of the stiff material abuts at a disk-shaped surface of the container cap and may be fixed to said surface e.g. by a suitable adhesive or other suitable means. Suitable elastic materials are e.g. cardboard or expanded polyethylene. The disc may comprise a single layer of a flexible material, e.g. expanded polyethylene. However, the disc made of flexible material may also comprise several layers, e.g. a layer made of cardboard which is covered by a foil, e.g. a plastic foil or an aluminum foil.

According to a preferred embodiment the seal is sealed to the flow-limiting device before inserting the flow-limiting device into said container cap. Sealing may be performed e.g. by heat welding. The seal, preferably the aluminum foil, optionally together with the disc made of a flexible material, are then firmly set into position relative to the flow-limiting device and, therefore will not slip out of its position during assembly of the flow-limiting device in the container cap.

To insert the flow-limiting device in its correct position inside the container cap, the container cap preferably is provided with a recess on the inner side of a flange wall of the container cap and said seal or said extensions of the seal protruding from the outer surface of the flow-limiting device, optionally placed with the disc made of a flexible material thereon, snap-fits into said recess. The recess is preferably situated in the inner flange surface close to the disk-shaped portion of the container cap. During mounting the container cap to the container body the flow-limiting device is firmly held in position. However, after sealing the seal to the container body the cap may be easily removed from the container body when reopening the container since the seal portion protruding from the outer circumference of the rim of the container opening and inserted into the recess of the container cap is easily removed from the recess. If a cardboard disc or a disc made from another flexible material is provided on top of the seal, the flexible disc will remain in the container cap upon reopening of the container and is held in position by the recess. When closing the cap again the disc made of a flexible material will be pressed against the upper peripheral edge of the container opening thereby providing a tight sealing of the container.

According to a preferred embodiment the recess provided on the inside of the container cap is formed as a circumferential inner groove and the seal optionally together with the disc made from a stiff material will snap-fit into said groove.

To allow repetitive access to the interior of the container, the container cap preferably is a screw cap and an outside “surface of a neck portion of the container body close to the container opening is provided with a thread corresponding to the thread integrally formed on the inside surface of the cap flange.

To allow easy discharge of a few or a single tablet or pill at a time the flow limiting device preferably comprises a cylindrical circumferential ring portion for at least partial abutment against the inner side of the container opening and a central area arranged distant from said circumferential ring, with at least two webs extending between the central area and the cylindrical circumferential ring such that through-openings are arranged between said webs distant from a center axis of said flow-limiting device.

The area of the through-openings preferably is selected corresponding to the size of the goods, e.g. tablets or pills, such that only a single tablet or pill will pass the through-hole at a time. There is no blocking barrier preventing the flow of the products through the individualizing through-opening. This is an important improvement for elderly users which then for discharging the product have to incline the container by only about 100 degrees, compared to its normal upright position, independent from the filling status of the container with the product. As a further advantage unintentionally dispersed tablets or pills may easily be reinserted into the container.

Being an insert, the flow-limiting device may be formed in a way which is adapted to the products to be discharged. Larger tablets, e.g., may require larger through-openings while the distribution and discharge of smaller pills or even granules is possible and better suitable with smaller through-openings.

Preferably, the flow-limiting device has a portion having a hemispherical, concave shape and the flow-limiting device is inserted such into the container opening, that the hemispherical portion of the flow-limiting device is directed into the interior of the container. By this structure, the reintroduction of pills, tablets, etc. is greatly facilitated, and the products may safely be discharged without blocking barrier. Preferably, the through-openings are arranged in said hemispherical portion of said flow-limiting device.

This concave arrangement is especially suitable for containers having a neck, i.e. a smaller diameter of the container opening than the container diameter. The neck, with this arrangement, may be short. At its outer portion, a suitable protruding rim or thread may be provided for fixing the cap of the container while the inner portion of the neck, close to the container opening, may be provided with suitable means for fixing the flow-limiting device. Such means may comprise at least one recess or at least one protrusion for allowing a snap-fit of the flow-limiting device, or suitable means for allowing a force-fit of the flow-limiting device in the container neck.

The cylindrical circumferential ring portion preferably is arranged adjacent to said hemispherical portion of said flow-limiting device with said through openings ending at said cylindrical circumferential ring, preferably at the transition from said hemispheric portion to said cylindrical portion. By the cylindrical circumferential portion a firm and secure fixation of the flow-limiting device is possible in the container body.

When tilting the container for removing a tablet or pill the product will pass the through opening at a site close to the cylindrical circumferential ring and therefore may easily be caught in the palm of a user's hand.

A further advantage of a concave arrangement of the flow-limiting device results from the curved rim or edge of each through-opening. This rim essentially guides the tablet or capsule thus facilitating its entrance into the through-opening and thus avoids a blockage or congestion during the discharge, even in the size of the through-openings of the flow-limiting device is only, e.g. 10%, wider than the width of the product to be discharged.

Preferably, the through-openings have side rims which extend essentially radially outward from said central area of said flow-limiting device.

The through-openings preferably have a width, in the tangential direction of the flow-limiting device, which increases towards the rim close to the cylindrical circumferential ring portion. The product, e.g. a tablet or pill, will leave the through opening at a place where the through opening is broadest. This elongated form also facilitates the discharge of e.g. capsules which may have a greater length than diameter. Thus, an efficient separation is possible without congestion.

According to a preferred embodiment, the cylindrical circumferential ring portion has a greater thickness than the remainder of said flow-limiting device. This measure reduces the weight of the flow-limiting device without impairing its stability.

Further, the webs extending between said through-openings preferably have a cross-sectional area between 30% and 70%, preferably about 50%, of the cross-sectional area of the flow limiting device.

According to a preferred embodiment the flow-limiting device has a symmetric form, with even distribution of through-openings around its central axis, and preferably has three through openings. By this arrangement the discharge is largely independent from the angle of rotation, if 3, 4, 5 or 6 or even more discharge through-openings are used.

The webs provided between the through-openings may be connected by a central area to thereby increase the stability of the flow-limiting device. This arrangement brings about a grid structure to the flow-limiting device with light weight combined with stability.

In its central area the flow-limiting device may have a central hole, preferably with a smaller cross-section than said through-openings. This measure further reduces the amount of material, e.g. a plastic material, needed for manufacturing the flow-limiting device.

According to a further embodiment, the through-openings extend to a central hole of said flow-limiting device and are connected to each other.

In this embodiment, said webs preferably have a width which increases outwardly, and said web preferably has the same or similar form as said through-opening.

For storage of moisture sensitive goods the flow-limiting device may be made from desiccant-entrained material, preferably from 2AP. By this, the separate insertion of a 2AP insert is redundant which even further reduces the weight of the container and also the production costs.

According to a further embodiment the flow-limiting device is made from plastic material and preferably is molded with a customized aroma.

A further advantage of the round shape leading to the concave arrangement of the flow-limiting device is that the container cap easily may be provided with desiccating agents, such as a sachet or a buckler depending from the center of the cap and being received in the flow limiting device when the cap is closed.

This arrangement is suitable for products which have to be kept dry to a large extend. An example are containers with products which have a storage time of several years.

The invention further refers to a container as obtained by a process as herein before described. Preferred embodiments of the container have been described in the course of the description of the production process according to the invention.

Further, the invention refers to a preassembled container cap comprising a flow-limiting-device as herein before described.

Further details, advantages and features may be taken from the following description of several embodiments of the present invention with reference to the drawings.

### BRIEF DESCRIPTION OF THE FIGURES

FIG. 1 is a perspective view of a flow-limiting device to be used in one embodiment of the production process according to the invention.

FIG. 2 is another perspective view of the flow-limiting device according to FIG. 1.

FIG. 3 is a view of the flow-limiting device according to FIG. 1, from the underside.

FIG. 4 is a top view of the flow-limiting device according to FIG. 1.

FIG. 5 is a side view of the flow-limiting device according to FIG. 1.

FIG. 6 is a perspective view of a further embodiment of a flow-limiting device to be used in the production process according to the invention.

FIG. 7 is an exploded perspective view of a container produced by the production process according to the invention.

FIG. 8 is a side view of the flow-limiting device representing a first step of the production process in which the seal is fixed to the flow-limiting device.

FIG. 9 is a side view showing the insertion of the flow-limiting device into the container cap.

FIG. 10 is a side view showing the assembly of the container cap to the container.

FIG. 11 is a side view for explaining the production step of sealing the seal to the rim of the container opening.

FIG. 12 is a side view explaining the reopening of the assembled container.

### DETAILED DESCRIPTION

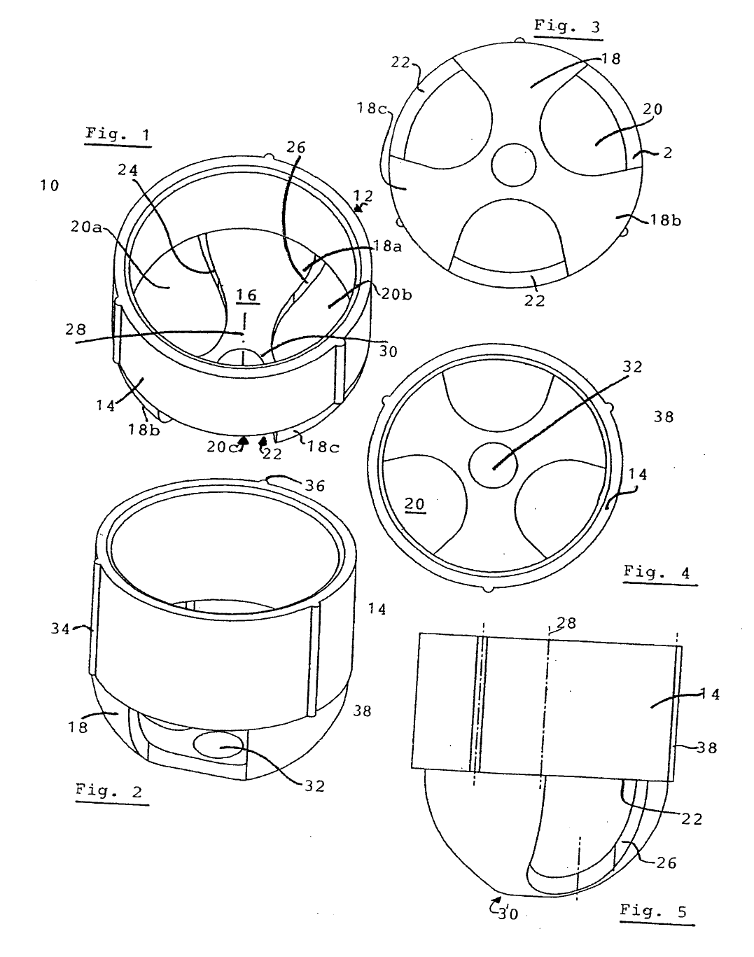

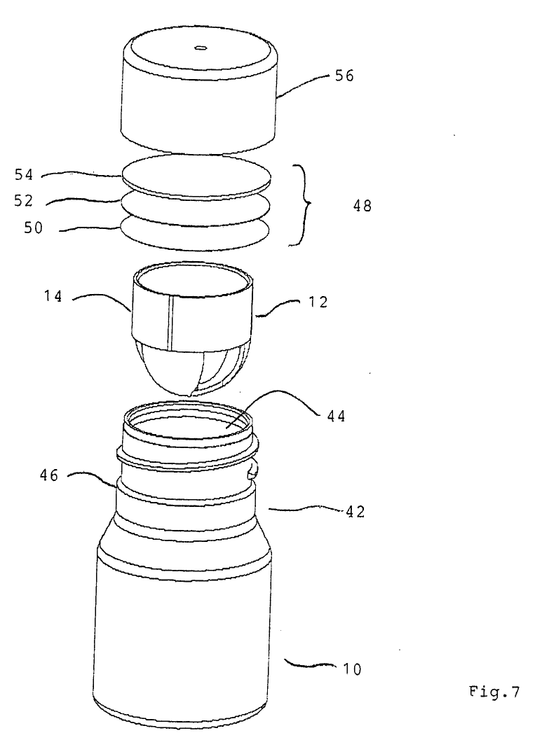

According to the embodiment of the invention shown in FIG. 1 to 5, a flow-limiting device 12 is provided which is suitable and adapted for being inserted to the upper portion of a container 10. An example for such an arrangement may be taken from FIG. 12 while also other containers without a neck, bottles, vials, etc. are possible without departing from the invention.

According to the embodiment shown in FIG. 1 to 5, the flow-limiting device comprises a cylindrical portion forming a ring 14 which at least partially abuts against the inner side of the container opening, and a hemispherical portion 16 which extends under said ring 14 and toward the interior of the container body when assembled, and is formed from a plurality of webs 18 and through-openings 20.

In the embodiment shown in FIG. 1 to 5, there are 3 webs 18a, 18b and 18c and three through-openings 20a, 20b and 20c. The webs and through-openings alternate to each other and can be evenly distributed and symmetrically arranged about a central axis (28).

According to the embodiment shown in FIG. 1 to 5, the through-openings 20a to 20c have a special form. They extend until to the ring 14 which forms a circumferential rim for each through-opening 20a to 20c. This circumferential rim may be provided with a chamfer facilitating the discharge of the products if the container is inclined only slightly more than the horizontal position, i.e. about 100 degrees to 110 degrees, compared to the upright position.

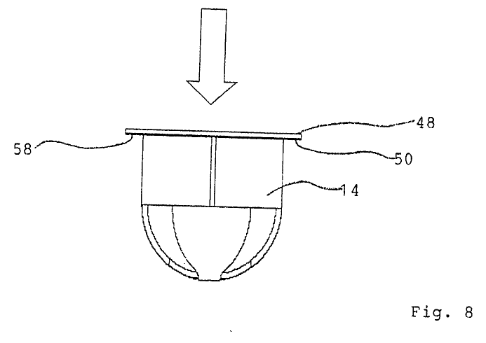

The circumferential rim 22 is clearly visible in FIG. 5 which, however, shows a rim without a chamfer.

Each through-opening 20 has two side rims, and the side rims 24 and 26 are clearly visible in FIG. 1. The side rims 24 and 26 essentially extend radially from a vertical axis 28 of the flow-limiting device 12 toward the ring 14. Thus, the width of the through-openings 20a to 20c and of the webs 18a to 18c increase outwardly, and it is preferred that the webs 18a to 18c and the through-openings 20a to 20c essentially have the same cross-sectional area. The total cross-sectional area of the webs should be between 30% and 70%, preferably about 50%, of the cross-sectional area of the flow limiting device 12.

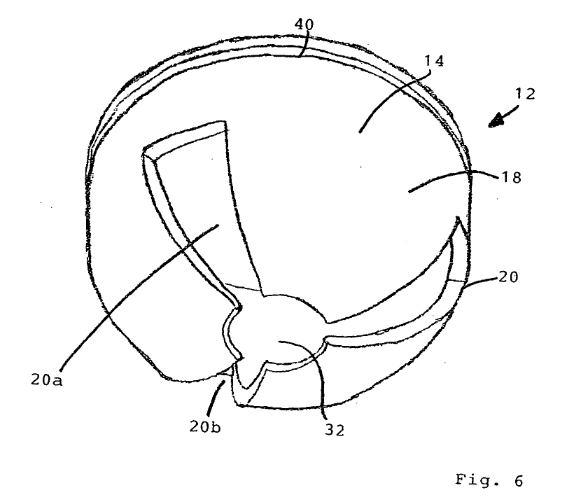

All three webs 18a to 18c are interconnected to each other via a central area 30 through which runs axis 28. In the embodiment shown in FIG. 1 to 5, the central area 30 is provided with a central hole 32 which may be taken from FIGS. 2, 3 and 4. The hole 32 preferably has a smaller cross-section than the through-openings.

As may be taken from FIG. 2, the thickness of the ring 14 is slightly larger than the thickness of the web 18. Thus, the flow limiting device 12 is stabilized and fixed by the ring 14 while the webs 18 stabilize each other by forming a grid structure. According to the embodiment shown in FIG. 1 to 5, the ring 14 is provided with three centering ribs 34, 36 and 38. These ribs are intended to abut an inner surface of a container neck or an upper container portion close to the container opening.

A further embodiment of the flow-limiting device may be taken from FIG. 6. This device has through-openings 20a, 20b and 20c which have a slot-form, yet with an outwardly increasing width. The through-openings 20a to 20c are interconnected with each other via a central hole 32. Thus, there is no central area 30 interconnecting webs 18 with each other. Instead, the width of each web 18 is considerably larger. By means of its curved and convex forms, each web 18 stabilizes itself while each web 18 is also attached to and preferably integrally molded with the ring 14, which, in this embodiment, has the same material thickness as the webs 18.

Contrary to the first embodiment, there is a circumferential rib 40 extending around the ring 18 and intended for snap-fit connection with the container.

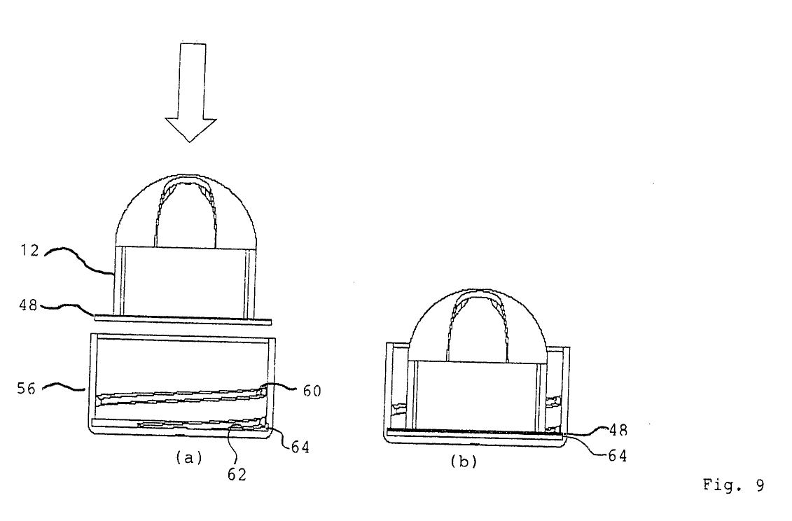

FIG. 7 displays an exploded perspective view of a container to be produced according to the process of the invention.

A container body 10 is provided with a neck portion 42 surrounding a container opening 44. On its outer surface neck portion 42 is provided with a thread 46. A flow-limiting device 12, such as displayed in FIGS. 1 to 5, has a diameter such that it may be fittingly inserted into container opening 44 and its ring portion 14 abuts at the inner surface of neck portion 42 of container body 10. On top of flow-limiting device 12 is placed joint 48 comprising a polyethylene disc or seal 50, an aluminum foil 52 acting as a seal and a cardboard disc 54. At least one tab is provided extending outward from the circumference of the seal (50, 52). Aluminum foil 52 is covered with a thin layer of a heat welding material 50 such as polyethylene or polypropylene to give a seal whereas cardboard disc 54 situated on the side of the aluminum foil opposite to the side of the polyethylene layer is only loosely attached to the aluminum foil. Joint 48 has a diameter larger than the outer diameter of ring portion 14 of the flow-limiting device 12 but small enough that joint 48 may be inserted into the inner portion of a screw cap 56.

When assembling the combination of sealed flow-limiting device and container cap to the container body, the flow-limiting device is fittingly inserted into the opening of the container and may be fixed in the container opening by e.g. frictional forces.

For storage of moisture sensitive goods the flow-limiting device may be made from desiccant-entrained material, preferably from 2AP. Alternatively, a desiccating element, preferably a desiccating sachet, can be provided in the interior of the flow-limiting device 12. Alternatively, the desiccating device can be attached to the cap 56 such that, when the cap is in the closed position, the desiccating element extends into the interior of the flow-limiting device 12.

The flow limiting device can be made from plastic material and even molded with a customized aroma.

In a first step of the production process displayed in FIG. 8 joint 48 is placed on top of ring portion 14 with the polyethylene disc or seal 50 facing towards flow-limiting device 12. Joint 48 has a larger diameter than the outside diameter of ring portion 14 and, therefore, forms a rib 58 protruding from the outer surface of ring portion 14. Polyethylene layer 50 is then sealed to the upper peripheral edge of ring portion 14 by heat welding.

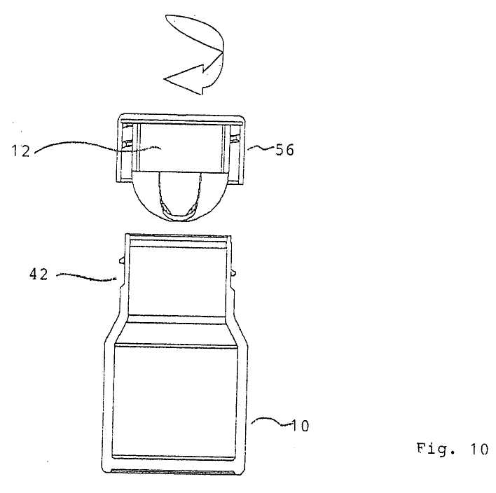

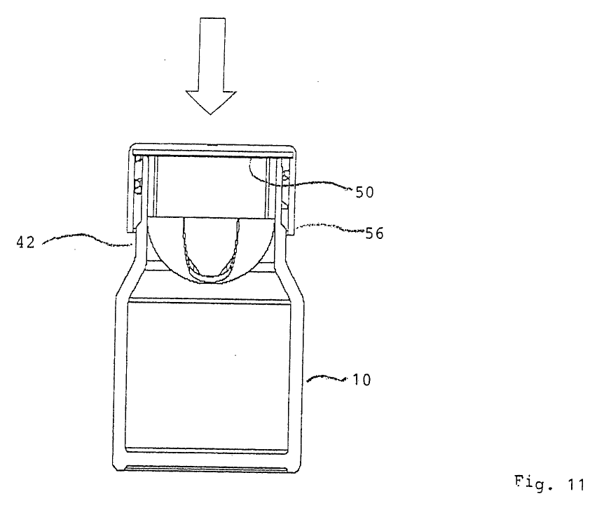

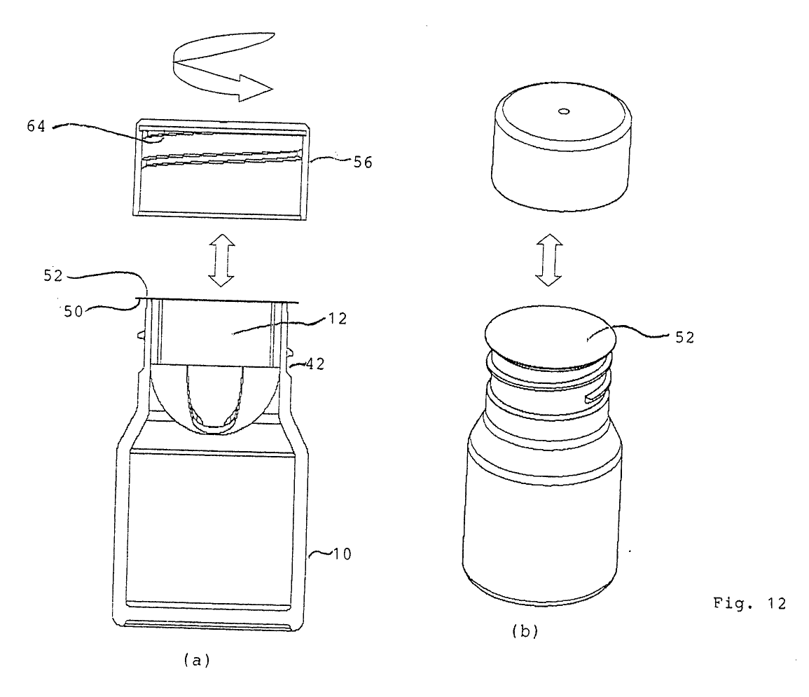

The assembly of flow-limiting device 12 and joint 48 is then inserted into cap 56 as shown in FIG. 9a. Screw cap 56 is provided on its inner circumferential surface with thread 60 corresponding to thread 46 situated on the outer surface of neck portion 42 of container 10. Further, close to horizontal inner surface 62 of screw cap 56 is provided a circumferential inner groove 64 in the inner surface of the container cap flange. Inner groove 64 has a depth such that it has a diameter corresponding to the diameter of joint 48. When completely inserted into screw cap 56 the flow-limiting device 12 is snap-fit by insertion of the outer circumference of joint 48 into inner groove 64 as shown in FIG. 9b. Container 10 and screw cap 56 with the inserted flow-limiting device 12 as shown in FIG. 10 are then shipped to a manufacturer site of e.g. pills or tablets. At the manufacturer container 10 is filled with loose products, e.g. tablets, and then screw cap 56 is screwed onto neck portion 42 of container 10 such that polyethylene disc 50 abuts to the upper peripheral edge of neck portion 42, as shown in FIG. 11. Polyethylene disc 50 is then sealed to the upper rim of neck portion 42, e.g. by induction heating to thereby fix the aluminum foil 52 as a seal covering container opening 44. An outer circumference of the flow limiting device 12 corresponds to an inner circumference of the container opening 44 and seal 50, 52 protrudes from the outer circumference of the flow limiting device 12. The container with the loosely stored products inside may then be shipped and sold to a customer.

When the customer wishes to take the product from the inside of the container screw cap 56 is unscrewed from neck portion 42 of container 10 as displayed in FIG. 12. During unscrewing joint 48 is separated in its constituents with the cardboard disc 54 remaining in the inside of screw cap 56 while aluminum foil 50 remains on top of the container opening as displayed in FIG. 12a. Therefore, the container opening remains sealed as shown in FIG. 12 b. For removing the loosely stored products the customer must break the seal by removing or breaking aluminum foil 52 thereby providing access to container opening 44 and flow-limiting device 12.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1. A production process for producing a container for loosely stored products, characterized in that a flow-limiting device (12) is preassembled in a container cap (56), the preassembled combination of flow-limiting device (12) and container cap (56) is put on and/or into a container body (10) and the flow-limiting device (12) is fixed in a container opening (44) of the container body (10).

2. A production process according to claim 1 characterized in that said flow-limiting device (12) is provided with a seal (50, 52) and inserted into said container cap (56), and wherein after putting that the combination of sealed flow-limiting device (12) and container cap (56) on and/or into said container body (10) said seal (50, 52) is sealed against said container body (10), preferably by induction heating.

3. A production process according to claim 2, characterized in that an outer circumference of the flow limiting device (12) corresponds to an inner circumference of the container opening (44) and said seal (50, 52) is placed on an upside surface of said flow limiting device (12) and protrudes from said outer circumference of said flow limiting device (12).

4. A production process according to claim 2, characterized in that said seal (50, 52) has the form of a disk.

5. A production process according to claim 2, characterized in that at least one tab is provided extending outwardly from the circumference of said seal (50, 52).

6. A production process according to claim 2, characterized in that said seal is formed by an aluminum foil (52).

7. A production process according to claim 6, characterized in that a layer of a heat welding material (50), preferably polyethylene or polypropylene, is placed onto the aluminum foil (52) and the aluminum foil (52) is sealed to said flow-limiting device (12) with the side the heat welding material is placed on.

8. A production process according to claim 6, characterized in that a disk (54) made of a flexible material is placed onto said aluminum foil (52).

9. A production process according to claim 2, characterized in that said seal (50, 52) is sealed to the flow-limiting device (12) before inserting the flow-limiting device (12) into said container cap (56).

10. A production process according to claim 2, characterized in that said container cap (56) is provided with a recess (64) on the inner side of a flange wall and said seal (50, 52) protruding from the outer circumference of the flow-limiting device (12) snap-fits into said recess (64).

11. A production process according to claim 10, characterized in that said recess is formed as a circumferential inner groove (64).

12. A production process according to claim 1, characterized in that said container cap is a screw cap and an outside surface of a neck portion (42) of the container body (10) close to the container opening (44) is provided with a corresponding thread (46).

13. A production process according to claim 1, characterized in that said flow limiting device (12) comprises a cylindrical circumferential ring portion (14) for at least partial abutment against the inner side of the container opening (44) and a central area (30) arranged distant from said circumferential ring (14), with at least two webs (18) extending between the central area (30) and the cylindrical circumferential ring (14) such that through-openings (20) are arranged between said webs (18) distant from a center axis (28) of said flow-limiting device (12).

14. A production process according to claim 1, characterized in that said flow-limiting device (12) has a portion (16) having a hemispherical shape and the flow-limiting device (12) is inserted into the container opening (44), such that the hemispherical portion (16) of the flow-limiting device (12) is directed into the interior of the container body (10).

15. A production process according to claim 14, characterized in that said through-openings (20) are arranged in said hemispherical portion (16) of said flow-limiting device (12).

16. A production process according to claim 15, characterized in that said cylindrical circumferential ring portion (14) is arranged adjacent to said hemispherical portion (16) of said flow-limiting device (12) with said through openings (20) ending at said cylindrical circumferential ring (14), preferably at the transition from said hemispheric portion (16) to said cylindrical portion (14).

17. A production process according to claim 13, characterized in that said through-openings (20) have curved side rims (24, 26).

18. A production process according to claim 13, characterized in that said through-openings (20) have side rims (24, 26) which extend essentially radially outward from said central area (30) of said flow-limiting device (12).

19. A production process according to claim 13, characterized in that said through-openings (20) have a width, in the tangential direction of the flow-limiting device (12), which increases towards the rim close to the cylindrical circumferential ring portion (14).

20. A production process according to claim 13, characterized in that said cylindrical circumferential ring portion (14) has a greater thickness than the remainder of said flow-limiting device (12).

21. A production process according to claim 13, characterized in that said webs (18) extending between said through openings (20) have a cross-sectional area between 30% and 70%, preferably about 50%, of the cross-sectional area of the flow limiting device (12).

22. A production process according to claim 13, characterized in that said flow-limiting device (12) has a symmetric form, with even distribution of through-openings (20) around its central axis (28), and preferably has three through openings (20).

23. A production process according to claim 13, characterized in that said flow-limiting device (12) has a central hole (32), preferably with a smaller cross-section than said through-openings (20).

24. A production process according to claim 13, characterized in that said through-openings (20) extend to a central hole (32) of said flow-limiting device (12) and are connected to each other.

25. A production process according to claim 24, characterized in that said webs (18) have a width which increases outwardly, and said web (18) preferably has the same or similar form as said through-opening (20).

26. A production process according to claim 1, characterized in that said flow-limiting device (12) is made from desiccant-entrained material, preferably from 2AP.

27. A production process according to claim 1, characterized in that said flow-limiting device (12) is made from plastic material and preferably is molded with a customized aroma.

28. A production process according to claim 1, characterized in that said flow-limiting device is snap-fit into the opening of the container, and preferably is form-fit or positive fit in said opening.

29. A production process according to claim 1, characterized in that said flow-limiting device (12) is held with friction in said container opening (44), and preferably is force-fit in said container (10).

30. A production process according claim 1, characterized in that a desiccating element, preferably a desiccating sachet, is provided in the interior of the flow-limiting device (12).

31. A production process according to claim 30, characterized in that the desiccating element is attached to said cap (56) such that, in the closed position of the cap (56), the desiccating element extends into the interior of the flow-limiting device (12).

32. Container for loosely stored products, obtained by a production process according to claims 1 to 31.

33. Preassembled container cap comprising a flow-limiting device (12) as defined in claims 13 to 27.
